(19) United States
(12) Patent Application Publication
(10) Pub. No.: US 2013/0297471 A1
(43) Pub. Date: Nov. 7, 2013

(54) METHOD OF GENERATING SOCIAL NETWORK NOTIFICATION WITHIN A GOAL BASED FINANCIAL ACCOUNT

(71) Applicant: SMARTYPIG, L.L.C., D.B.A. SOCIAL MONEY, West Des Moines, IA (US)

(72) Inventor: Jon M. Gaskell, II, West Des Moines, IA (US)

(73) Assignee: SmartyPig, L.L.C., d.b.a. Social Money, West Des Moines, IA (US)

(21) Appl. No.: 13/875,804

(22) Filed: May 2, 2013

Related U.S. Application Data
(60) Provisional application No. 61/641,332, filed on May 2, 2012.

(51) Int. Cl. G06Q 40/00; G06Q 50/00

(52) U.S. Cl. CPC G06Q 40/00; G06Q 50/01
USPC 705/35

(57) ABSTRACT

A method of generating social network posts and tweets based on financial account activity in a goal based financial account where posts and tweets are configurable by the financial account owner. Bank account owners are permitted to configure the message of the posts and tweets, the account activity that generates the notification(s), when the notification(s) is sent to the social network, and which social network site(s) receive the notification(s). Once generated and sent to social network sites, the notification is viewable through the account owner's wall on that social network.

### CROSS REFERENCE TO RELATED APPLICATION

This application claims the benefit of U.S. Provisional Application No. 61/641,332 filed May 2, 2012.

### BACKGROUND OF THE INVENTION

This invention is directed toward a method of generating social network posts and tweets based on financial account activity and more specifically generating automated, customized posts based on the activity of a goal based savings or demand deposit account (DDA).

As the Internet and social networking have become more prevalent, entities such as financial institutions are challenged to develop a social network presence. While various social networks and savings programs are known in the art, utilizing automated and customized posts based on account activity to post messages to social networks is difficult as often the two networks do not communicate and the information of one is independent of another. Accordingly, there exists a need in the art for a method or system that addresses these deficiencies.

Therefore, an object of the present invention is to provide a method to customers to customize and automate posts and tweets to their social networks based on activity in their goal based savings or DDA account.

A further objective of this invention is to provide a method where activity related to a savings or DDA account is managed.

A still further objective of the present invention is a user software interface to provide a method of customization for the account owner and control over the automated communication being posted based on their savings or DDA account activity.

These and other objective will be apparent to one skilled in the art based upon the following written description, drawings and claims.

### BRIEF SUMMARY OF THE INVENTION

The method of generating social network notification within a goal based financial account activity includes a goal based financial savings or DDA account having an online user software interface. The user software interface permits the scheduling and configuration of automated posts. Once configured through the user software interface, posts and tweets to social networks are scheduled to automatically occur when the designated activity is performed to the savings account or DDA.

The user software interface works with a management software interface that permits targeted messaging to be sent to consumers' social network sites based on criteria determined and controlled by the consumer. This user software interface and management software interface together enable a consumer of a financial institution to t post and tweet automated messages to their social network based on their preferences and activity.

### BRIEF DESCRIPTION OF THE DRAWINGS

FIG. 1 is a schematic diagram of the environment for a method of generating a notification; and

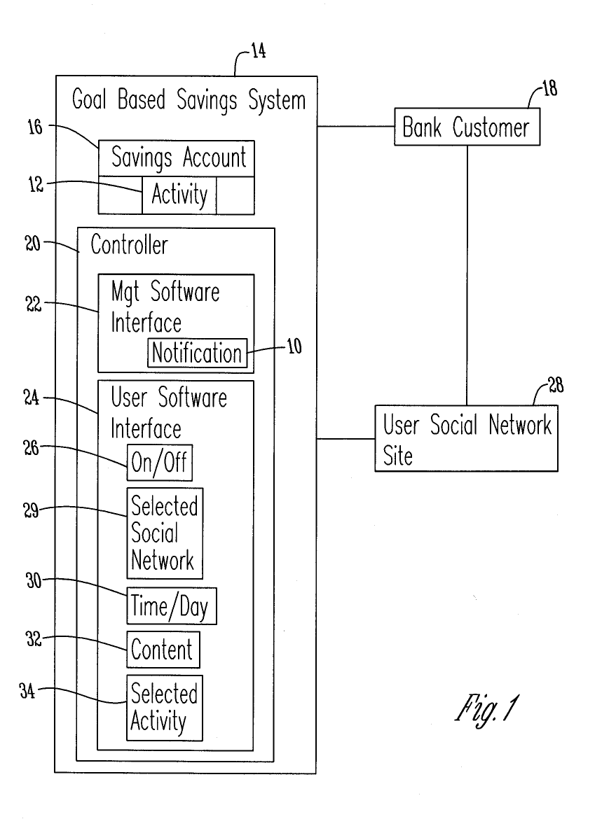

FIG. 2 is a flow diagram of a method of generating a notification.

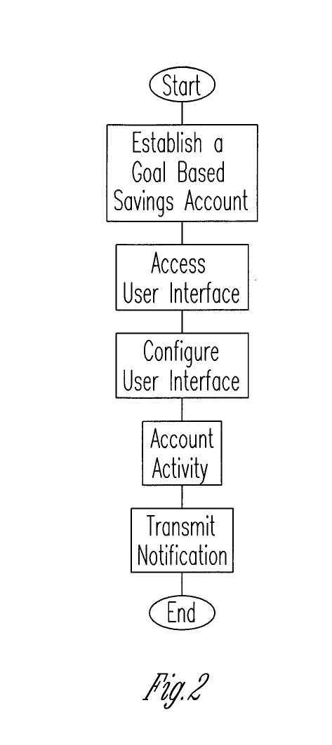

### DETAILED DESCRIPTION OF THE PREFERRED EMBODIMENTS

A method of generating social network notifications 10 such as posts and tweets based on financial account activity 12 includes a goal based savings system 14 that is integrated into and connected to a savings account 16. The savings account 16 is offered to an existing bank customer 18, who can elect to sign up for a bank account 16 integrated with the goal based savings system 14. Once an account 16 with the goal based savings system 14 is opened, the goal based savings system 14 has a controller 20, a management software interface 22 where functionality of the account is managed, and a user software interface 24. Within the user software interface 24 is the ability for the bank customer 18 to manage the setup and configure their goal based savings account 16. The user software interface 24 and management software interface 22 are both accessed through an electronic network.

The user software interface 24, accessed by the bank customer 18, can be used to configure posts and tweets (notifications) 10 based on activity 12 to that account 16. Through the user software interface 24, the bank customer 18 can turn the notifications 10 on or off 26. When configured to the on position, posts and tweets 10 will be generated when the pre-defined activity 12 occurs. When set to the off position, posts and tweets will not be generated. The user can also tie the notifications 10 to different social networks 28, so posts and tweets will only be generated to selected social networks 29 configured and requested here. The user 18 can also determine when 30 the notifications 10 will be generated, be it real time or a set time and day. The user 18 can also determine the content 32 of the notifications 10 and the corresponding account action 34 that will kick off the notification 10.

When an action 12 occurs to the account 16 that is configured to kick off a notification 10, the management user interface 22 will generate a post or tweet 10. This post or tweet 10 will be transmitted/sent to the requested social network 29 on the time and day 30 determined by the user's configuration. The content 32 of the post and tweet 10 will also be determined by the user's configuration. Once generated and sent to the social network 28, the post or tweet 10 will then be viewable on the wall of the user's external social network(s) 28.

What is claimed is:

1. A method of generating a social network notification comprising:
establishing a goal based saving system that includes a saving's account, a management software interface, and a user software interface connected to a controller;
configuring the user software interface by accessing the user software interface via an electronic network; and
transmitting a notification from the management software interface via the electronic network to at least one user social network site based upon a monetary transaction to the savings account and the configured user software interface.

2. The method of claim 1 wherein the user software interface is configured to be one of off and on.

3. The method of claim 1 wherein the user software interface is configured to selected user social network sites.

4. The method of claim 1 wherein the user software interface is configured to send the notification at a predetermined time.

5. The method of claim 1 wherein the user software interface is configured to determine content of the notification.

6. The method of claim 1 wherein the user software interface is configured to send the notification based upon specific monetary transactions.
